(19) United States
(12) Patent Application Publication
(10) Pub. No.: US 2008/0289044 A1
(43) Pub. Date: Nov. 20, 2008

(54) Apparatus, system, and method for storing DRM licenses

(75) Inventor: Yong Seock CHOI, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 12/152,433

(22) Filed: May 14, 2008

(30) Foreign Application Priority Data
May 18, 2007 (KR) 2007-0048533

(51) Int. Cl. G06F 21/00

(52) U.S. Cl. 726/26

(57) ABSTRACT

An apparatus, system and method for storing licenses of digital rights management (DRM) contents are disclosed. The DRM license storing apparatus, system and method save DRM licenses in a separate location of a mobile terminal or an external server, and enable license restoration even in the case of loss or replacement of the mobile terminal. The apparatus includes a memory unit for storing DRM contents; a user identification module for storing licenses of DRM contents; and a control unit for verifying, in response to a play request for a DRM content, validity of a license associated with the play-requested DRM content through communication with the user identification module.

### CLAIM OF PRIORITY

This application claims priority from an application entitled “APPARATUS, SYSTEM, AND METHOD FOR STORING DRM LICENSES” filed in the Korean Intellectual Property Office on May 18, 2007 and assigned Serial No. 2007-0048533, the contents of which are incorporated herein by reference in its entirety.

### BACKGROUND OF THE INVENTION

1. Field of the Invention

The present invention relates generally to digital rights management (DRM) contents. More particularly, the present invention relates to a DRM license storing apparatus, system, and method for storing DRM licenses in a separate storage unit separated from a mobile terminal, such as a universal subscriber identity module (USIM) or an external server, and enables access to the separate storage unit for utilizing the DRM licenses stored in the separate storage unit.

2. Description of the Related Art

Digital rights management (DRM) relates to the protection and management of copyrighted digital contents. Using cryptography, DRM aims to achieve secure delivery of various contents from content providers to authorized users, and to prevent unauthorized redistribution of contents delivered to users. DRM supports the full life cycle of digital contents including creation, distribution, usage and retirement, both in on-line and off-line states, on the basis of the rights of users.

In order to use a DRM-protected content (or DRM content) in a mobile terminal, the user of the mobile terminal connects to a DRM content server and downloads (1) a desired DRM content, (2) metadata on the DRM content, and (3) a license. The metadata provides information regarding the DRM content. The license contains a decryption key for decryption of the encrypted DRM content, and provides the terms of the usage rights upon the DRM content (for example, the number of plays and expiration dates). After downloading the DRM content with the associated metadata and license in the mobile terminal, the user is authorized and able to use the downloaded DRM content within the terms of the usage rights specified in the license.

As described above, playback of a DRM content requires acquisition of an associated license. The user of a mobile terminal pays a license fee to a DRM license issuing server for a desired DRM content and downloads the DRM content and associated license. In the case where the license is based on usage, the amount of remaining rights in the license, which is stored in the mobile terminal, decreases as the user uses the DRM content. When the rights stated in the license are exhausted, the user may purchase/renew the same license from the DRM license issuing server for continuous use of the DRM content. However, when the user obtains a new mobile terminal because the previous mobile terminal may have been lost, stolen, not functioning, or the user decided to upgrade to a new phone, the user cannot transfer and use the license stored in the old mobile terminal to access the DRM content. Thus, the user has paid for rights that they cannot use, which can negatively impact the user's perception of purchasing DRM content and may adversely affect decisions to purchase additional DRM content in the future.

### SUMMARY OF THE INVENTION

The present invention has been made in part in light of the aforementioned problems, and to provide advantages as described herein below. The present invention provides a DRM license storing apparatus, system, and method that saves a DRM license and license-related information in a separate storage medium and enables restoration of the DRM license using the separate storage medium, even in the case of replacement or loss of a mobile terminal.

In accordance with an embodiment of the present invention, there is provided a license storing apparatus for storing digital rights management (DRM) contents, typically including: a memory unit for storing DRM contents; a user identification module for storing licenses of DRM contents; and a control unit for verifying, in response to a play request for a DRM content, validity of a license associated with the play-requested DRM content through communication with the user identification module.

In accordance with another embodiment of the present invention, there is provided a license storing system of digital rights management (DRM) contents, typically including: a mobile terminal for storing DRM contents, licenses of the DRM contents, and a license list of at least one license; and a content server for receiving a license list from the mobile terminal and storing the received license list.

In accordance with yet another embodiment of the present invention, there is provided a license storing method of digital rights management contents, typically including: checking whether a license backup mode is set; and storing, if the license backup mode is set, a license in a user identification module.

In accordance with another embodiment of the present invention, there is provided a license storing method for storing digital rights management contents, including: creating, if a license backup mode is set, a license list of stored licenses; transmitting the created license list to an external content server; and storing the license list as a backup.

In accordance with another embodiment of the present invention, there is provided a license storing method for storing digital rights management contents, including: storing, if a license backup mode is set, a license in a user identification module; creating a license list of stored licenses; transmitting the created license list to an external content server; and storing the license list as a backup.

### BRIEF DESCRIPTION OF THE DRAWINGS

The features and advantages of the present invention will become more apparent from the following detailed description in conjunction with the accompanying drawings, in which:

FIG. 1 illustrates a configuration of a DRM license storing system according to an embodiment of the present invention;

FIG. 2 illustrates a configuration of a mobile terminal according to another embodiment of the present invention;

FIG. 3 illustrates a configuration of a content server according to another embodiment of the present invention;

FIG. 4 illustrates a configuration of a mobile terminal according to another embodiment of the present invention;

FIG. 5 illustrates layers between elements of the DRM license storing system of FIG. 1;

FIG. 6 is a sequence diagram illustrating a DRM license storing method according to another embodiment of the present invention;

FIG. 7 is a flow chart illustrating the DRM license storing method of FIG. 6;

FIG. 8 is a flow chart illustrating a DRM license storing method according to another embodiment of the present invention; and

FIG. 9 is a sequence diagram illustrating a DRM license storing method according to another embodiment of the present invention.

### DETAILED DESCRIPTION

Hereinafter, embodiments of the present invention are described in detail with reference to the accompanying drawings. The same reference symbols are used to identify the same or corresponding elements in the drawings. Detailed descriptions of constructions or processes known in the art may be omitted to avoid obscuring appreciation of the invention by a person of ordinary skill in the art with unnecessary detail regarding such known constructions and functions. Particular terms may be defined to describe the invention in the best mode as known by the inventors. Accordingly, the meaning of specific terms or words used in the specification and the claims should not be limited to the literal or commonly employed sense, but should be construed in accordance with the spirit and scope of the invention. The description of the various embodiments is to be construed as exemplary only for illustrative purposes, and does not describe every possible instance of the invention. Therefore, it should be understood that various changes may be made and equivalents may be substituted for elements of the invention.

The present invention relates to a method and apparatus for playback of DRM contents. The user can use a DRM content within the scope of rights specified in an associated license. For example, if the license states a usage duration, the user can use the DRM content only within the usage duration (time count based). If the license states the allowed usage time, the user can use the DRM content only when the accumulated usage time is not greater than the allowed usage time (accumulated time based). The present invention is not limited to a particular expression of usage rights or a particular way that the usage time or duration is measured.

In the following description, a mobile terminal according to a first exemplary embodiment does not have a universal subscriber identity module (USIM). A mobile terminal according to a second embodiment has a USIM. That is, a mobile terminal according to the second embodiment can include a USIM, and a handset to which the USIM is attached.

For the illustrative purposes, a mobile communication terminal is described as an example of a mobile terminal according to the present invention, however, the present invention is not limited to a mobile communication terminal. The mobile terminal of the present invention is a terminal that can use DRM contents, and may be any information and communication appliance or multimedia appliance, such as a gaming terminal, mobile communication terminal capable of providing a multimedia messaging service or multimedia mail service, mobile phone, wired/wireless phone, personal digital assistant (PDA), smart phone, digital broadcast receiving terminal, notebook, personal computer, wideband code division multiple access (WCDMA) terminal, portable Internet (Wibro) terminal, international mobile telecommunications 2000 (IMT 2000) terminal, global system for mobile communications (GSM)/general packet radio services (GPRS) terminal, or universal mobile telecommunications system (UMTS) terminal.

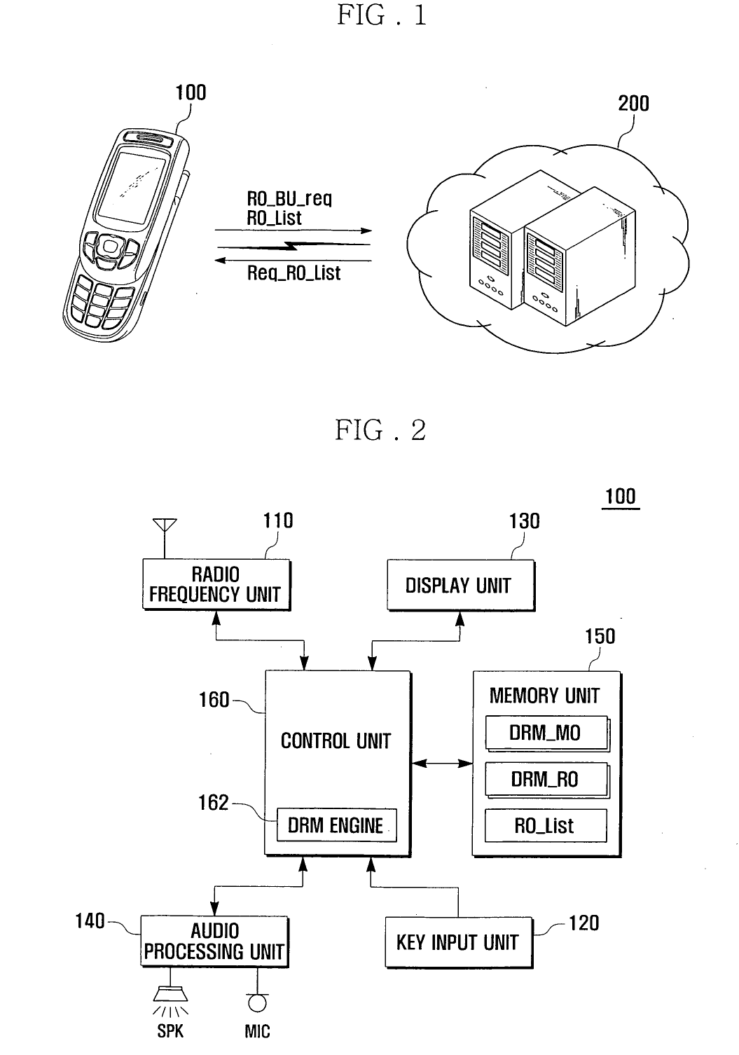

FIG. 1 illustrates a configuration of a DRM license storing system according to an exemplary embodiment of the present invention.

Referring to FIG. 1, the DRM license storing system includes a content server 200 and a mobile terminal 100.

The content server 200 provides DRM contents to the mobile terminal 100, and manages licenses associated with the DRM contents. That is, the content server 200 saves/records licenses, which are downloaded to the mobile terminal 100, as a backup file, and transmits a saved license to the mobile terminal 100 upon request.

Still referring to FIG. 1, in reply to a license backup request message RO_BU_req from the mobile terminal 100, the content server 200 sends a license list request message Req_RO_List to the mobile terminal 100. The license list request message Req_RO_List corresponds to an acknowledgment signal to the license backup request message RO_BU_req that is sent by the mobile terminal 100 for backing up a license.

The mobile terminal 100 downloads a DRM content and associated license from the content server 200. The mobile terminal 100 sends a license backup request message RO_BU_req for backing up the downloaded license to the content server 200. The license backup request message RO_BU_req is a message that is created by the mobile terminal 100 to backup a downloaded license at the content server 200. In response to a license list request message Req_RO_List from the content server 200, the mobile terminal 100 sends a license list RO_List to the content server 200. The license list RO_List is a list containing information on licenses associated with DRM contents. The license list RO_List can contain current status of individual licenses, including but not limited to items such as remaining rights. When a right related to a license is changed as a result of use of the license, the mobile terminal 100 preferably creates a new license list RO_List and sends the new license list RO_List to the content server 200.

As described above, the DRM license storing system stores information on licenses, which are downloaded by the mobile terminal 100, in the content server 200 as a backup. When the mobile terminal 100 cannot be used due to loss, failure, etc., the user can recover the remaining rights and use a desired license by receiving the backed up information.

Hereinafter, elements of the DRM license storing system are described in more detail.

FIG. 2 illustrates a configuration of a mobile terminal 100 according to another exemplary embodiment of the present invention.

Referring to FIG. 2, the mobile terminal 100 may typically include, for example, a radio frequency unit 110, key input unit 120, display unit 130, audio processing unit 140, memory unit 150, and control unit 160.

The radio frequency unit 110 establishes a communication channel to the content server 200 under the control of the control unit 160, and receives a DRM content DRM_MO and associated license DRM_RO from the content server 200. In addition, the radio frequency unit 110 may include a radio frequency transmitter for upconverting the frequency of a signal to be transmitted and amplifying the signal, and a radio frequency receiver for low-noise amplification of a received signal and for downconverting the frequency of the received signal.

In this particular example, the radio frequency unit 110 sends a license backup request message RO_BU_req and a license list RO_List to the content server 200, and receives a license list request message Req_RO_List from the content server 200. The radio frequency unit 110 can also send a new license list RO_List to the content server 200 whenever a right related to a license is updated as a result of use of the license.

The key input unit 120 includes a plurality of alphanumeric and function keys for inputting alphanumeric information and for setting various functions. The function keys may include direction, side, and shortcut keys associated with corresponding functions. The key input unit 120 transmits key signals from the user for setting and controlling the mobile terminal 100 to the control unit 160.

In particular, the key input unit 120 can generate key input signals for connecting to the content server 200, for selecting a desired DRM content DRM_MO and associated license DRM_RO, for selecting a stored DRM content DRM_MO, and for requesting license backup. A key input signal for a license backup request can be a signal associated with a menu item or shortcut key depending upon the design of the mobile terminal 100.

When license backup is set by default, a key input signal for a license backup request is automatically generated, without a separate key input, in response to downloading of a license DRM_RO from the content server 200.

Still referring to FIG. 2, the audio processing unit 140 typically includes a speaker SPK for reproducing audio data during activation of a DRM content DRM_MO stored in the memory unit 150, and a microphone MIC for collecting an audio signal during a voice call.

The display unit 130 provides an idle screen of the mobile terminal 100, playback screen for DRM contents DRM_MO, and other menu option screens. The display unit 130 may include a panel of liquid crystal display (LCD) devices, LCD controller, and memory device for storing image data to be displayed. If the panel has a touch screen capability, the display unit 130 can also act as an input means.

In particular, the display unit 130 can display alarms indicating transmission of a license backup request message RO_BU_req and a license list RO_List. In addition, the display unit 130 may provide a screen interface for a license backup.

The memory unit 150 stores application programs necessary for implementing functions of the present embodiment, DRM contents DRM_MO and associated licenses DRM_RO received from the content server 200, and user data. The memory unit 150 provides a buffer space of a preset size for the data of a DRM content DRM_MO being downloaded. The memory unit 150 can include, for example, a program memory section and data memory section.

The program memory section typically stores an operating system for booting the mobile terminal 100, application programs for playing back DRM contents DRM_MO, application programs for supplementary functions of the mobile terminal 100 related to voice calls, camera photographing, and sound reproduction, and playing of image and video data. When one of these functions is activated in response to a user request, the mobile terminal 100 executes a corresponding application program under the control of the control unit 160.

The data memory section of memory unit 150 is an area that typically stores data generating from the use of the mobile terminal 100, and stores DRM contents DRM_MO, licenses DRM_RO, and license list RO_List. The data memory section typically stores various user data, data related to supplementary functions of the mobile terminal 100, such as photographed images, moving images, phonebook data and audio data, and information regarding contents or user data. The license list RO_List typically comprises summary information, created by the control unit 160, regarding licenses DRM_RO in the memory unit 150.

The control unit 160 controls downloading of a DRM content DRM_MO and associated license DRM_RO from the content server 200, and also controls storage and activation of the downloaded DRM content DRM_MO and license DRM_RO. The control unit 160 can control activation of basic functions such as, for example, voice communication, and can control activation of supplementary functions according to signals input from the key input unit 120. The control unit 160 can include a modulator/demodulator (modem) for voice and data communication. In particular, the control unit 160 may also include a DRM engine 162 for managing DRM contents DRM_MO and licenses DRM_RO.

The DRM engine 162 controls activation of a DRM content DRM_MO stored in the memory unit 150 according to a signal input from the key input unit 120. Therefore, the DRM engine 162 checks the validity of the associated license DRM_RO stored in the memory unit 150. If the license DRM_RO is valid, the DRM engine 162 controls playback of the DRM content DRM_MO. The DRM engine 162 can collect information regarding rights of licenses DRM_RO stored in the memory unit 150, create a license list RO_List, and send the created license list RO_List to the content server 200. According to settings for license backup, the DRM engine 162 can create a license list RO_List and send the created license list RO_List to the content server 200 immediately after downloading of a license DRM_RO.

At times specified by the user, the DRM engine 162 can examine licenses DRM_RO in the memory unit 150 to collect information on usage rights, create a license list RO_List using the collected information, and send the created license list RO_List to the content server 200. As a license DRM_RO is updated as a result of use of a corresponding DRM content DRM_MO, the DRM engine 162 can create a new license list RO_List and send the new license list RO_List to the content server 200. The DRM engine 162 can send a license list RO_List in the form of a message or in the form of packets to the content server 200. The transmission mode may be varied according to characteristics of a communication channel between the mobile terminal 100 and content server 200.

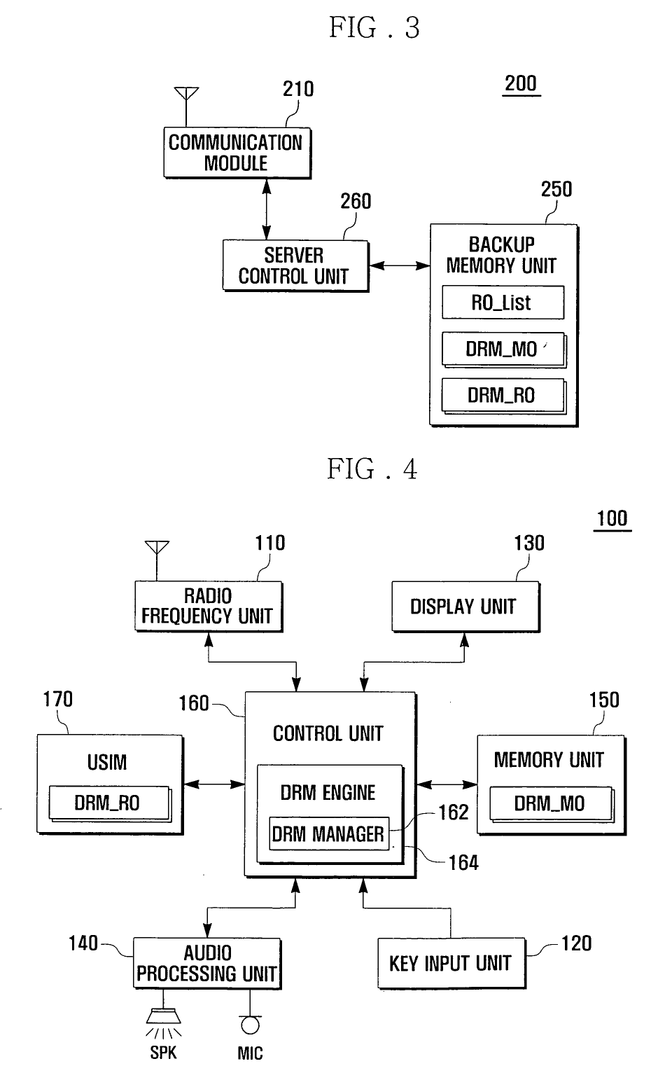

FIG. 3 illustrates a configuration of the content server 200 according to another exemplary embodiment of the present invention.

Referring to FIG. 3, the content server 200 typically includes a communication module 210, server control unit 260, and backup memory unit 250. The content server 200 may further include a monitor, key input unit, audio processing unit and the like according to the design.

The communication module 210 establishes a communication channel to the radio frequency unit 110 of the mobile terminal 100 (such as shown in FIGS. 2 and 4, for example) under the control of the server control unit 260. The communication module 210 receives a license backup request message RO_BU_req and license list RO_List from the mobile terminal 100, and sends a license list request message Req_RO_List to the mobile terminal 100, under the control of the server control unit 260. The communication channel may include a data channel for transmission of a DRM content DRM_MO and license DRM_RO, and a mobile communication channel for transmission of the above messages. These messages may also be sent and received through the data channel.

The server control unit 260 provides a DRM content DRM_MO and associated license DRM_RO to the mobile terminal 100. The server control unit 260 controls the communication module 210 to receive a license backup request message RO_BU_req and a license list RO_List from the mobile terminal 100, and stores the received license backup request message RO_BU_req and license list RO_List in the backup memory unit 250. In response to a restoration request from the mobile terminal 100 for a particular license in the license list RO_List, the server control unit 260 sends the restoration-requested license to the mobile terminal 100. Here, the remaining amount of a right of a license in the license list RO_List is decreased in proportion to the use by the mobile terminal 100. When a mobile terminal requests restoration of a license, the content server 200 may authenticate the user of the requesting mobile terminal using a separate authentication server. For example, the requesting mobile terminal must be a terminal pre-registered in the authentication server, and the server control unit 260 can initiate license restoration on the basis of the registration.

The backup memory unit 250 stores DRM contents DRM_MO, licenses DRM_RO, and license lists RO_List. In particular, the backup memory unit 250 preferably stores license lists RO_List in a table together with information on the user of the mobile terminal 100. The backup memory unit 250 preferably updates the license list RO_List according to changes in licenses caused by the use in the mobile terminal 100. In addition, the mobile terminal 100 sends information on licenses updated by the use of DRM contents DRM_MO as messages or packets to the content server 200. Hence, the backup memory unit 250 can update the license list RO_List on the basis of the license update information from the mobile terminal 100. The content server 200 may include a separate storage space for storing DRM contents DRM_MO and licenses DRM_RO to be provided to the mobile terminal 100.

As described above, the DRM license storing system of the present exemplary embodiment enables storage of a license in a separate external storage medium, update of the license, and restoration of the license upon loss or replacement of a mobile terminal.

FIG. 4 illustrates a configuration of a mobile terminal according to another exemplary embodiment of the present invention. Some elements of the mobile terminal in FIG. 4 are identical to corresponding elements of the mobile terminal in FIG. 2, and repeated descriptions are omitted. The same reference symbols identify the same or corresponding elements.

Referring to FIG. 4, the mobile terminal 100 typically includes a radio frequency unit 110, key input unit 120, display unit 130, audio processing unit 140, memory unit 150, USIM 170, and control unit 160.

The memory unit 150 stores application programs necessary for booting the mobile terminal 100 and implementing functions thereof, and user data. In particular, the memory unit 150 stores DRM contents DRM_MO downloaded from the content server 200.

The USIM 170 is a user identification module. The USIM 170 is typically attachable to and detachable from the mobile terminal 100, and can include a storage area for storing data and a central processing unit for controlling operations to read and write data from and to the storage area. The central processing unit communicates with the control unit 160 via a communication interface, and can load information from the storage area to the memory unit 150. The communication interface can be adapted for wired or wireless transmission, which may include optical transmission. In particular, the storage area of the USIM 170 stores licenses DRM_RO provided by the content server 200. When the mobile terminal 100 tries to activate a DRM content DRM_MO, an associated license DRM_RO stored in the USIM 170 is used to validate the playback right of the DRM content DRM_MO through communication between the control unit 160 and central processing unit. The USIM 170 preferably communicates with the control unit 160 through a protocol such as Bearer Independent Protocol (BIP). In addition, the USIM 170 can directly connect to the content server 200 through BIP, and download a license DRM_RO. That is, for license downloading, the USIM 170 can connect to the content server 200 through layers including a TCP layer, IP layer and GPRS layer, formed by the control unit 160, without passing the memory unit 150, and can directly download a desired license DRM_RO from the content server 200 and store the downloaded license DRM_RO in the storage area. Accordingly, the user of the mobile terminal 100 can detach the USIM 170 from the mobile terminal 100 and keep the USIM 170 separately, and thereby licenses DRM_RO can be kept and carried independently of a mobile terminal.

The control unit 160 activates internal elements, and controls signal exchange between the internal elements. The control unit 160 can include a DRM engine 162 for activating a DRM content DRM_MO in the memory unit 150. The DRM engine 162 can include a DRM manager 164 for communicating with the USIM 170 to use a corresponding license DRM_RO.

When the DRM engine 162 tries to activate a selected DRM content DRM_MO in response to an input signal from the key input unit 120, the DRM manager 164 checks whether a license DRM_RO associated with the DRM content DRM_MO is present in the USIM 170. That is, the DRM manager 164 communicates with the USIM 170, checks the presence of the associated license DRM_RO, and also checks the validity of the license DRM_RO if present. The DRM manager 164 considers the USIM 170 as a separate area storing licenses DRM_RO, and communicates with the USIM 170 through a preset protocol. The protocol may be BIP as described previously. BIP is a protocol that can be used for the USIM 170 to send and receive data of a desired size to and from the content server 200 through a TCP/IP connection using commands such as ‘open channel’, ‘send data’, ‘receive data’ and ‘close channel’.

The mobile terminal 100 of FIG. 4 can build a SIM application toolkit (SAT) menu during menu construction, and aid the user to set a license backup menu. That is, the user can select the SAT menu through the key input unit 120, and select the license backup menu for activation. On activation of the license backup menu, the USIM 170 and control unit 160 typically communicate with each other to transfer a license DRM_RO associated with a selected DRM content DRM_MO to the storage area of the USIM 170. For fair use, the license DRM_RO can be saved only in the USIM 170.

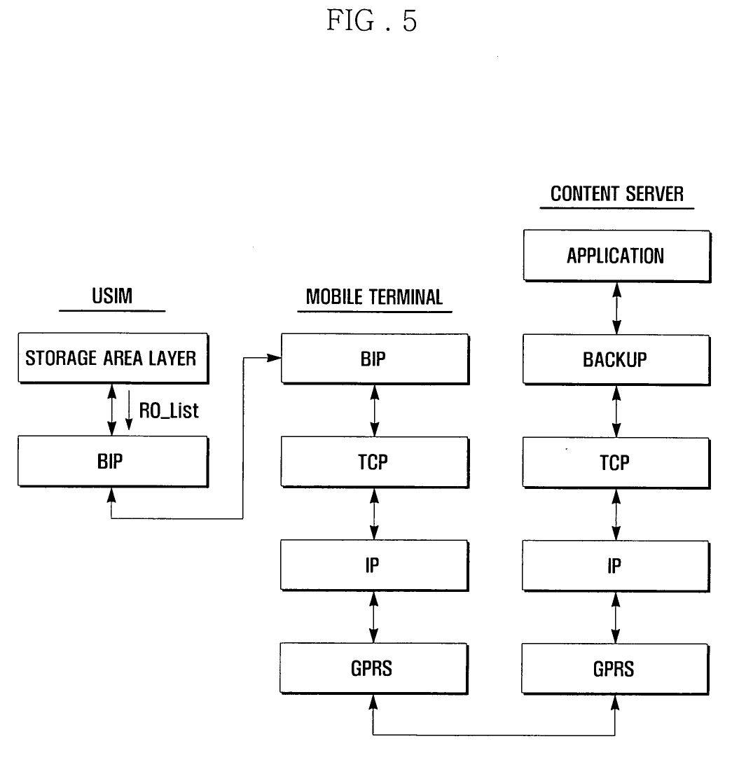

The mobile terminal 100 of FIG. 4 can backup licenses DRM_RO of the USIM 170 to the content server 200, as illustrated in FIG. 5.

Referring to FIG. 5, the mobile terminal 100 can connect to the content server 200 and backup a license list RO_List of licenses DRM_RO in the USIM 170 to the content server 200. The USIM 170 includes a storage area layer and BIP layer; the mobile terminal 100 includes a BIP layer, Transmission Control Protocol (TCP) layer, Internet Protocol (IP) layer, and GPRS layer; and the content server 200 includes an application layer, backup layer, TCP layer, IP layer, and GPRS layer. The GPRS layer may be replaced with another layer according to characteristics of a service providing network for the mobile terminal 100. For license backup, a license list RO_List is created at the USIM 170, and transmitted through the BIP layer of the USIM 170 to the BIP layer of the mobile terminal 100. Next, the license list RO_List at the mobile terminal 100 is transmitted through the BIP layer, TCP layer, IP layer, and GPRS layer to the network. Then, the license list RO_List is transmitted through the network to the content server 200, at which the license list RO_List is stored at the backup layer via the GPRS layer, IP layer, and TCP layer. The application layer of the content server 200 controls backup of the license list RO_List. When a right of a DRM content DRM_MO is reduced as a result of use, the USIM 170 sends license update information to the content server 200, which then can update the stored license list RO_List.

As described above, the DRM license storing system of the present exemplary embodiment permits a USIM to be detached from a mobile terminal for high portability, and enables continuous use of the same DRM content using another mobile terminal that is equipped with the USIM. In addition, a backup of licenses in a USIM can be made on the content server. Thus, even in the case of loss of the USIM, the licenses can be recovered from the content server without having to repurchase the license.

Hereinabove, the configuration and operation of the DRM license storing system are described. Next, DRM license storing methods are described.

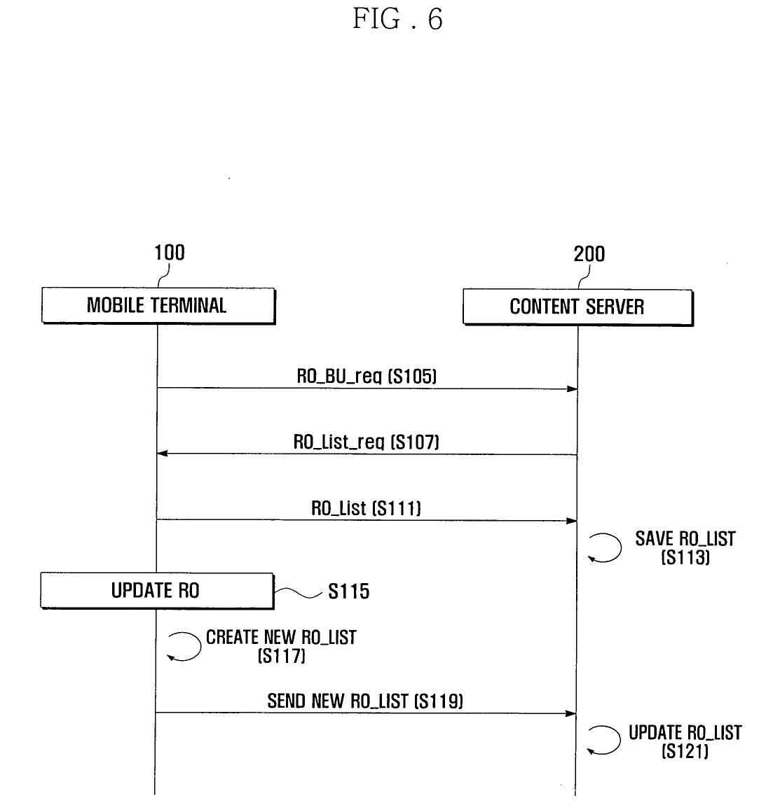

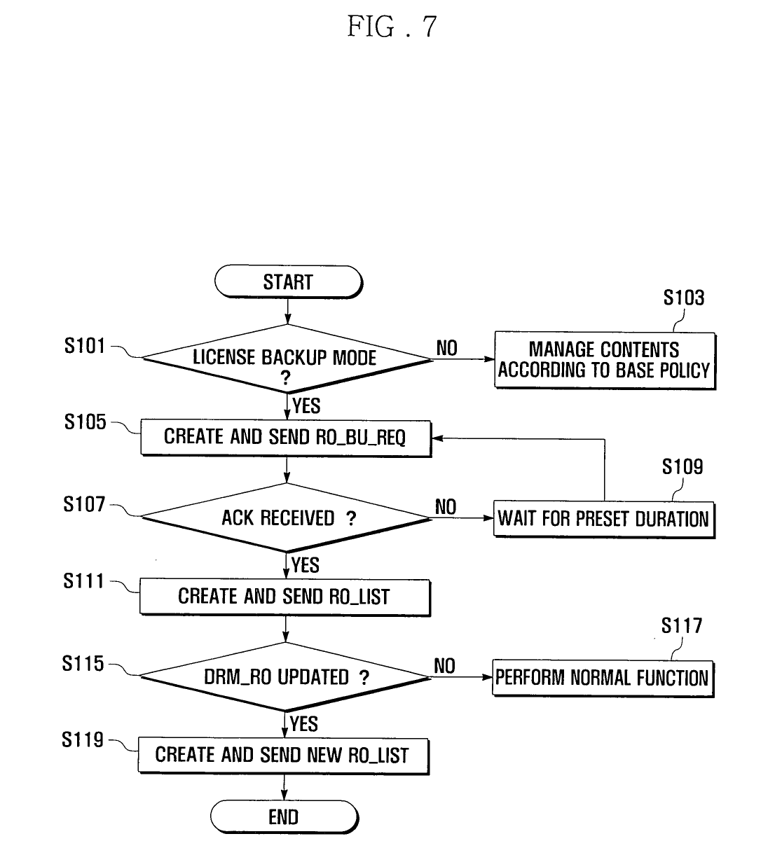

FIG. 6 is a sequence diagram illustrating a DRM license storing method according to another exemplary embodiment of the present invention. FIG. 7 is a flow chart illustrating the DRM license storing method of FIG. 6. In the following description, the mobile terminal 100 is assumed to already have licenses DRM_RO to be backed up.

Referring to FIGS. 6 and 7, the mobile terminal 100 checks whether a license backup mode is set (S101). The license backup mode is a mode that licenses DRM_RO necessary for playback of DRM contents DRM_MO and histories of the licenses DRM_RO are saved at an external server such as the content server 200. A history of a license DRM_RO stored in the mobile terminal 100 indicates the current status of the license DRM_RO, and can include information on reduction and modification of a usage right.

Still referring to FIG. 7, if the license backup mode is not set at step S101, the mobile terminal 100 manages the storage and use of a license DRM_RO according to a base policy (S103). In the base policy, licenses DRM_RO are used and managed in the memory unit 150 without separate backup.

If the license backup mode is set at step S101, the mobile terminal 100 creates a license backup request message RO_BU_req for making a backup of licenses DRM_RO in the memory unit 150, and sends the created license backup request message RO_BU_req to the content server 200 (S105). The mobile terminal 100 checks whether a response message (typically an acknowledgement) to the license backup request message RO_BU_req is received (S107). That is, in reply to the license backup request message RO_BU_req, the content server 200 sends a license list request message Req_RO_List to the mobile terminal 100. The mobile terminal 100 then receives the license list request message Req_RO_List as an acknowledgement message for the license backup request message RO_BU_req.

If a response message is not received at step S107, the mobile terminal 100 waits for a preset time duration (S109) and returns to step S105 for retransmission of the license backup request message RO_BU_req to the content server 200. If a response message is received at step S107, the mobile terminal 100 collects licenses DRM_RO in the memory unit 150, creates a license list RO_List, and sends the created license list RO_List to the content server 200 (S111). The license list RO_List indicates information regarding licenses DRM_RO in the memory unit 150, and can include an identifier of the mobile terminal 100, identifiers of available licenses DRM_RO, and information on the current status of rights of the licenses DRM_RO.

The content server 200 receives the license list RO_List from the mobile terminal 100, and saves the received license list RO_List (S113) (see FIG. 6).

After license backup at the content server 200, the mobile terminal 100 checks whether a license DRM_RO is updated (S115). If no license DRM_RO is updated, the mobile terminal 100 performs a normal function (S117). Examples of a normal function include voice call processing, camera photographing, gaming, searching or playback of a DRM content DRM_MO not involving license update. If a license DRM_RO is updated, the mobile terminal 100 creates a new license list RO_List, and sends the new license list RO_List to the content server 200 (S119). A new license list RO_List can be created when a right of a license DRM_RO is changed as a result of activation of an associated DRM content DRM_MO. A new license list RO_List can be created in real time whenever a license DRM_RO is updated. Alternatively, licenses DRM_RO are examined at regular intervals, and a new license list RO_List can be created if a license DRM_RO is updated. Upon reception of the new license list RO_List, the content server 200 updates the existing license list RO_List on the basis of details of the new license list RO_List (S121) (see FIG. 6).

As described above, the DRM license storing method according to the present exemplary embodiment enables storage of licenses in an external content server. Thus, even in the case of the loss or replacement of the mobile terminal, the licenses can be recovered using information saved in the content server without repurchasing the license in the previous terminal.

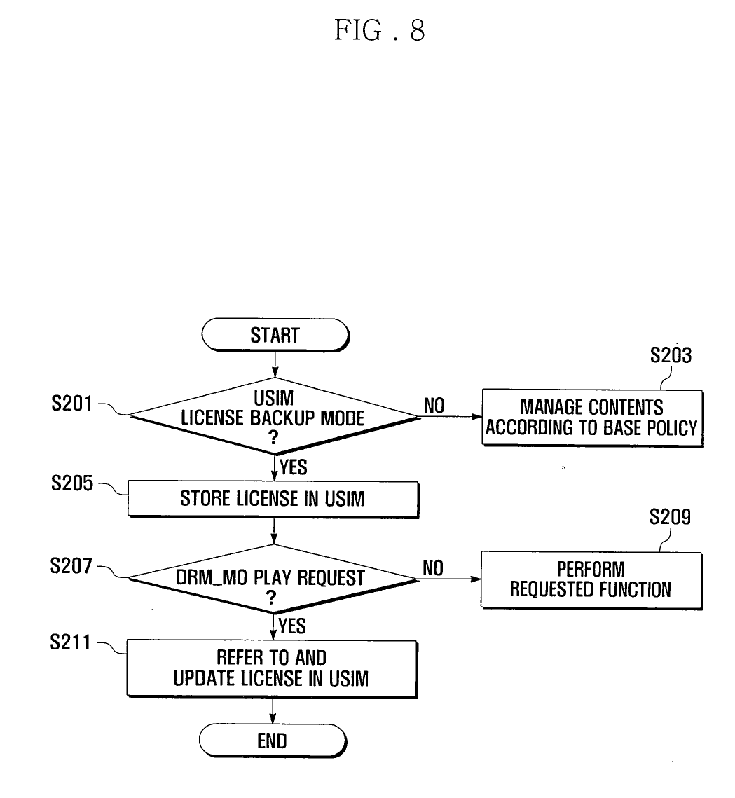

FIG. 8 is a flow chart illustrating a DRM license storing method according to another exemplary embodiment of the present invention. In the description related to FIG. 8, the mobile terminal 100 includes a USIM for user identification, and a handset in which the USIM can be installed.

Referring to FIG. 8, the handset checks whether a USIM license backup mode is set (S201). In the USIM license backup mode, licenses DRM_RO necessary for playback of DRM contents DRM_MO are stored in the USIM; and when a selected DRM content DRM_MO is activated, a corresponding license DRM_RO in the USIM is referred to. The USIM can include a storage area for storing licenses DRM_RO, and a central processing unit for communicating with the handset. The USIM can use a protocol such as BIP to communicate with the handset. The handset has a SAT menu including a license backup mode item for setting the USIM license backup mode, and can provide a screen interface for the SAT menu. If the USIM license backup mode is not set at step S201, the handset manages licenses DRM_RO according to a base policy (S203). In the base policy, licenses DRM_RO are used and managed in the memory unit and are not stored in the USIM.

If the USIM license backup mode is set at step S201, the handset stores a license DRM_RO in the USIM (S205). In the USIM license backup mode, when a license DRM_RO is downloaded from the content server 200, the USIM directly stores the downloaded license DRM_RO in the storage area using a protocol such as BIP.

In response to a key input from the key input unit 120 (an example shown in FIGS. 2 and 4), the handset checks whether the key input is a playback request for a DRM content DRM_MO (S207). If the key input is not a playback request, the handset can perform a requested function of the mobile terminal 100 (S209). Examples of a requested function include voice call processing, camera photographing, and playback of a content or DRM content file not involving license update.

If the key input is a playback request for a DRM content DRM_MO, the handset refers to a license DRM_RO associated with the requested DRM content DRM_MO in the storage area of the USIM, and updates the license DRM_RO on the basis of use (S211).

As described above, the DRM license storing method of FIG. 8 enables storage of licenses DRM_RO in the USIM, and the licenses DRM_RO can be moved and managed through detachment of the USIM.

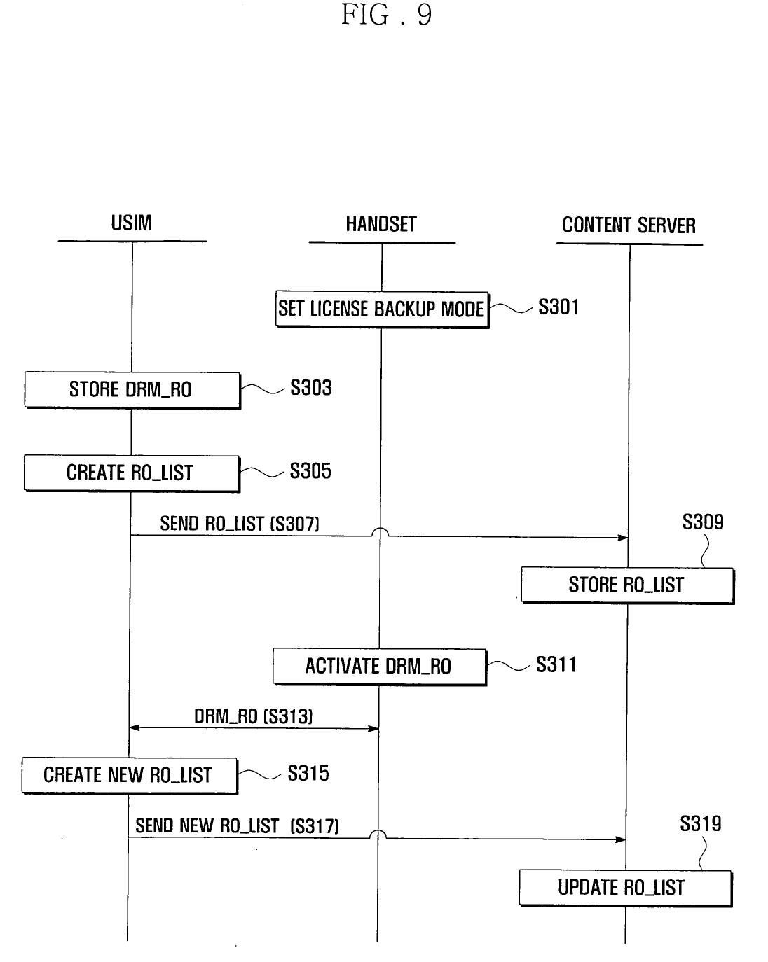

FIG. 9 is a sequence diagram illustrating a DRM license storing method according to another exemplary embodiment of the present invention. In the description related to FIG. 9, the mobile terminal 100 includes a USIM for user identification, and a handset to which the USIM can be attached.

Referring to FIG. 9, the handset checks whether a license backup mode is set (S301). The license backup mode is a mode in which a license backup function is typically provided as an option. However, it is within the spirit of the invention and the scope of the appended claims that there can be a periodic entry into backup mode that can be set by the user or provided as a default.

If the license backup mode is set, the USIM stores licenses DRM_RO provided from the handset in the storage area (S303). The license DRM_RO may be a license that has been stored in the memory unit of the handset or downloaded from the content server 200. Thereafter, the licenses DRM_RO in the memory unit are preferably removed for fair license use.

The USIM creates a license list RO_List of licenses DRM_RO stored in the storage area (S305). The license list RO_List indicates information regarding licenses DRM_RO in the memory unit 150, and can include an identifier of the handset or mobile terminal, identifiers of available licenses DRM_RO in the USIM, and information on the current status of rights of the licenses DRM_RO. The license list RO_List may be in the form of a list or table.

The USIM sends the created license list RO_List to the content server 200 (S307). The USIM can establish various communication channels such as a data communication channel and mobile communication channel. Hence, the USIM can send the license list RO_List as a message to the content server 200 through a mobile communication channel. The USIM can also send the license list RO_List as data packets to the content server 200 through a data communication channel.

The content server 200 receives the license list RO_List, and stores the received license list RO_List in the backup memory unit 250 (S309). Preferably, the content server 200 stores the license list RO_List in the backup memory unit 250 in a manner corresponding to the mobile terminal 100. Thereto, the content server 200 can store the license list RO_List in a database.

Still referring to FIG. 9, after license saving in the USIM, the handset checks whether to activate a DRM content DRM_MO (S311). When the handset tries to activate a DRM content DRM_MO in response to an input key from the key input unit 120, it communicates with the USIM to refer a corresponding license DRM_RO in the USIM. The USIM can determine whether a DRM content DRM_MO is activated, on the basis of the reference to an associated license DRM_RO.

If a DRM content DRM_MO is to be activated at step S311, the USIM and handset communicate with each other through a protocol so that the handset can refer to an associated license DRM_RO in the USIM (S313). Thereafter, the USIM checks whether the associated license DRM_RO is updated as a result of activation of the DRM content DRM_MO (S315).

If the associated license DRM_RO is updated, the USIM creates a communication channel to the content server 200, and sends a new license list RO_List to the content server 200 (S317). Then, the content server 200 updates the existing license list RO_List using details of the new license list RO_List (S319).

As described above, the DRM license storing method of FIG. 9 enables saving and management of licenses in a separate content server, thereby preventing loss of licenses due to loss and damage of the USIM.

Preferably, license restoration with a new mobile terminal using the content server 200 is performed after the new mobile terminal or the USIM is registered in an authentication server and the right to use a license stored in the content server 200 is verified. Thereto, user identification information such as an identifier and password is preferably pre-registered in the authentication server for authentication of the user.

As apparent from the above description, the present invention provides a DRM license storing apparatus, system, and method that save DRM licenses in a separate location and enable license restoration even in the case of loss or replacement of a mobile terminal.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A license storing apparatus for digital rights management (DRM) contents, comprising:
a memory unit for storing DRM contents;
an attachable/detachable user identification module for storing licenses of DRM contents; and
a control unit for verifying, in response to a play request for a DRM content, validity of a license associated with the play-requested DRM content through communication with the user identification module.

2. The license storing apparatus of claim 1, wherein the user identification module comprises:
a storage area for storing a license; and
a central processing unit for communicating with the control unit; and
a communication interface for communicating with the license storing apparatus and a source of DRM contents.

3. The license storing apparatus of claim 2, wherein the user identification module downloads the DRM contents.

4. The license storing apparatus of claim 1, wherein the user identification module retains stored licenses when detached from the apparatus.

5. A license storing system for digital rights management (DRM) contents, comprising:
a mobile terminal for storing DRM contents, licenses of the DRM contents, and a license list of at least one license; and
a content server for receiving the license list from the mobile terminal and storing the received license list.

6. The license storing system of claim 5, wherein the mobile terminal comprises:
a memory unit for storing DRM contents, licenses of the DRM contents, and a license list of the at least one license;
a radio frequency unit for transmitting the license list to the content server; and
a control unit for controlling the radio frequency unit to establish a communication channel to the content server and for controlling transmission of the license list to the content server.

7. The license storing system of claim 6, wherein the control unit creates a new license list and sends the new license list to the content server, when a license is to be updated as a result of playback of a corresponding DRM content.

8. The license storing system of claim 7, wherein the content server updates the stored license list based on details in the new license list.

9. The license storing system of claim 6, wherein the control unit periodically examining licenses in the memory unit to detect an updated license as a result of playback of a corresponding DRM content, creating a new license list if an updated license is found, and sending the new license list to the content server.

10. The license storing system of claim 5, wherein the mobile terminal comprises:
a memory unit for storing DRM contents;
a user identification module for storing licenses of the DRM contents and the license list of the at least one license;
a radio frequency unit for sending the license list to the content server; and
a control unit for controlling the radio frequency unit to establish a communication channel to the content server and for controlling transmission of the license list to the content server.

11. The license storing system of claim 10, wherein the user identification module comprises:
a storage area for storing a license; and
a central processing unit for communicating with the control unit.

12. The license storing system of claim 10, wherein the user identification module is attachable to and detachable from the mobile terminal.

13. The license storing system of claim 5, wherein the content server comprises:
a communication module for establishing a communication channel to the mobile terminal;
a backup memory unit for storing the license list from the mobile terminal; and
a server control unit for controlling the communication module to transfer a particular received license list to the backup memory unit.

14. A license storing method for digital rights management (DRM) contents, comprising:
checking whether a license backup mode has been set; and
storing a license in a user identification module if the license backup mode has been set.

15. The license storing method of claim 14, further comprising removing a version of the license from a memory unit after saving the license in the user identification module.

16. The license storing method of claim 14, further comprising storing a license from an external source in the user identification module if the license backup mode has been set.

17. A license storing method for digital rights management (DRM) contents, comprising:
creating a license list of stored licenses if a license backup mode is set;
transmitting the created license list to an external content server; and
storing the license list as a backup.

18. The license storing method of claim 17, further comprising:
checking whether a license is updated;
creating a new license list if a license is updated;
transmitting the new license list to the content server; and
updating the stored license list based on details in the new license list.

19. The license storing method of claim 17, further comprising:
checking at regular intervals whether a license is updated;
creating a new license list if a license is updated;
transmitting the new license list to the content server; and
updating the stored license list based on details in the new license list.

20. A license storing method for digital rights management (DRM) contents, comprising:
storing a license in a user identification module if a license backup mode is set;
creating a license list of stored licenses;
transmitting the created license list to an external content server; and
storing the license list as a backup.

21. The license storing method of claim 20, further comprising:
checking whether a license is updated;
creating a new license list if a license is updated;
transmitting the new license list to the content server; and
updating the stored license list based on details in the new license list.

22. The license storing method of claim 20, further comprising:
checking at regular intervals whether a license is updated;
creating a new license list if a license is updated;
transmitting the new license list to the content server; and
updating the stored license list based on details in the new license list.

23. The license storing method of claim 20, further comprising removing a version of the license from a memory unit after saving the license in the user identification module.

24. The license storing method of claim 20, further comprising storing a license from an external source in the user identification module if the license backup mode is set.
